(19) United States
(12) Patent Application Publication
(10) Pub. No.: US 2024/0354600 A1
(43) Pub. Date: Oct. 24, 2024

(54) METHOD FOR EFFICIENT AI FEATURE LIFECYCLE MANAGEMENT THROUGH AI MODEL UPDATES

(71) Applicant: Clari Inc., Sunnyvale, CA (US)

(72) Inventors: Jon PARK, Dublin, CA (US); Xi YANG, Santa Clara, CA (US); Eugene FRATKIN, Redwood City, CA (US)

(21) Appl. No.: 18/304,710

(22) Filed: Apr. 21, 2023

(51) Int. Cl. G06N 5/022

(52) U.S. Cl. CPC G06N 5/022

(57) ABSTRACT

In an embodiment, a method of managing AI model rollouts can include the operations of training, by a cloud environment, a second AI model, wherein the second AI model outputs a same AI feature as a first AI model in the cloud environment; specifying, by the cloud environment, a rollout window in which the second AI model is to be released to a plurality of tenant applications; and displaying, by the cloud environment, an output value to each of the plurality of tenant applications based on a timestamp associated with the tenant application, wherein the output value is one of an output value of the first AI model, an output value of the second AI model, or a combined output value of the first AI model and the second AI model.

### TECHNICAL FIELD

Embodiments of the present invention relate generally to artificial intelligence (AI). More particularly, embodiments of the invention relate to managing AI model rollouts to reduce disruptive user experience.

### BACKGROUND

Artificial intelligence (AI) models for AI applications are becoming increasingly sophisticated and frequently updated through updated data. Output values of AI features—functionality that an AI model is trained to perform—are closely tied to an AI model. Thus, the release of the updated AI model may often result in undesirable user experience due to a sudden gap in the values of the AI feature, and accordingly, tenants (also referred to as users or customers or organization in this disclosure) often may require explanations for the disruptions from service providers, which is time-consuming. Therefore, there is a need to smooth the disruptive user experiences caused by AI model rollouts.

There is also an increasing need for an AI model version rollout strategy to be customized per tenant. Configuring, deploying and managing end-to-end machine learning pipeline per tenant creates overhead, and distracts a data science team from innovating. Although industry tools—such as machine learning model operations platform (MLOps)—can be used to help manage and track ML model deployments, these tools lack the flexibility to configure and manage the ML pipeline at the tenant-level granularity.

### BRIEF DESCRIPTION OF THE DRAWINGS

Embodiments of the invention are illustrated by way of example and are not limited to the figures of the accompanying drawings, in which like references indicate similar elements.

FIG. 1 is a schematic diagram illustrating a system for managing artificial intelligence (AI) model rollouts according to an embodiment of the invention.

FIG. 2 illustrates specific use cases for the system according to an embodiment of the invention.

FIG. 3 illustrates a system of combining output values of AI features from multiple AI models according to an embodiment of the invention.

FIG. 4 illustrates a rollout process for an AI model according to an embodiment of the invention.

FIG. 5 illustrates a process of managing AI model rollouts according to an embodiment of the invention.

FIG. 6 is a block diagram illustrating an example system of training a machine learning model for predicting probabilities of task completion in accordance with an embodiment.

FIG. 7 is a block diagram illustrating an example of a data processing system which may be used with any embodiment of the invention.

### DETAILED DESCRIPTION

Various embodiments and aspects of the inventions will be described with reference to the details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to “one embodiment” or “an embodiment” means that a particular feature, structure, or characteristic described in conjunction with the embodiment can be included in at least one embodiment of the invention. The appearances of the phrase “in one embodiment” or “in an embodiment” in various places in the specification do not necessarily all refer to the same embodiment.

To address the problems described above, the disclosure describes various embodiments for managing AI model rollouts to smooth user experience, and for rolling out AI models at the tenant-level granularity.

In an embodiment, a method of managing AI model rollouts can include the operations of training, by a cloud environment a second AI model, wherein the second AI model outputs a same AI feature as a first AI model in the cloud environment; specifying, by the cloud environment, a window of time in which the second AI model is to be rolled out to a plurality of tenant applications; and displaying, by the cloud environment, an output value to each of the plurality of tenant applications based on a timestamp associated with the tenant application, wherein the output value is one of an output value of the first AI model, an output value of the second AI model, or a combined output value of the first AI model and the second AI model.

In an embodiment, the timestamp represents a time when the tenant application is signed up for receiving the output value from the cloud environment, and the combined output value is generated using a smoothing algorithm running in the cloud environment.

In an embodiment, the smoothing algorithm takes an weighted average of the output value from the first AI model and the output value from the second AI model to generate the combined output value. An weight of the output value of the first AI model gradually decreases from a start of the rollout window to and an end of the rollout window, and an weight of the output value of the second AI model proportionally decreases.

In an embodiment, the weight of the output value of the first AI model is 100% and the weight of the output value of the second AI model is 0 at the start of the rollout window, and the weight of the output value of the first AI model is 0 and the weight of the output value of the second AI model is 100% at the end of the rollout window.

In an embodiment, the output value displayed to each of the plurality of tenant applications is accompanied by a plurality of explanatory factors. When the output value is the combined output value of the first AI model and the second AI model, the plurality of explanatory factors include more explanatory factors from one of the first AI model or the second AI model with a greater weight given in generating the combined output value.

In an embodiment, the output value displayed by the cloud environment to each of the plurality of tenant applications is a prediction score representing a probability that a task is to be successfully closed.

The various embodiments include configuration-driven machine learning execution at the tenant-level granularity, which eliminates the need for a pipeline code change, as each tenant's ML pipeline requirement is updated asynchronously. The various embodiments are also algorithm agnostics and cloud/ML infrastructure agnostics, as the embodiments provide flexibility to manage different types of models and mix different ML platforms or cloud functionalities in the ML pipelines.

Thus, the various embodiments present a number of advantages, including less communication overhead to tenants, user level customized rollout of new models, less tenant support resulting from a gap between output values of the different versions of AI models, and faster and more flexible innovation by data science teams by abstracting ML pipelines and deployment management per tenant.

The other embodiments, functions and advantages will be apparent from the accompanying drawings and from the detailed description that follows.

### Glossary

Throughout the disclosure, the following terms are used:

AI feature: As used herein, an AI feature refers to the functionality of an AI model. For example, for an AI model trained to generate a probability score for a task, the probability score is the AI feature of the AI model. The same AI feature may be provided by different versions of the same AI model. Each version of the same AI model effectively is a different AI model. A different version of the AI model may be generated by retraining a previous version on a different data segment and/or by implementing different algorithms. Thus, in this document, an AI feature in this document is different from the feature in “feature map” or “feature vector” in the context of AI, and also different from an output value of an AI model in that the output value is a concrete example of the AI feature. In the above example, the probability score is the AI feature, and a probability score of 80% is an output value. However, an value of the AI feature is used interchangeably with an output value of the AI model that generates the AI feature.

AI model: As used herein, an AI model refers to a trained model machine learning model, which can be a neural network model. Each version of the AI model is considered a different AI model. There can be three types of AI model versions in this disclosure: major version, minor version, and version. A major version represents an AI feature change that might involve major algorithm changes, which can lead to the output interface changes. A minor version represents an AI feature change that could involve little or no algorithm changes, which lead to no output attribute or interface changes. Thus, a rollout of a minor version is less visible to customers. A version, on the other hand, is an AI model version generated via retraining, which uses exactly the same algorithm and code as a previous version, but with refreshed data as the training data used to train the new version. Smoothing may not be needed in this case as it has little impact on customers.

Endpoint: As used herein, an endpoint refers to a location used to serve one or more AI models trained using the same algorithm. Examples of endpoints include a physical device, a server on a physical device, and a virtual machine on a physical device.

Algorithm: As used herein, an algorithm is a machine learning or statistical approach to computing a value of an AI feature.

Deployment: As used herein, deployment is the action of deploying a trained AI model to one or more endpoints to serve the AI model.

Segment: As used herein, a segment refers to a segment of an entire data set of an organization (customer/user/tenant). For example, an organization's deals can be segmented into small deals and large deals. The small deals can be considered a segment, and the large deals can be considered another segment. Segmenting the data set into different segments enables different AI models to be trained on different segments, which can improve inference performance.

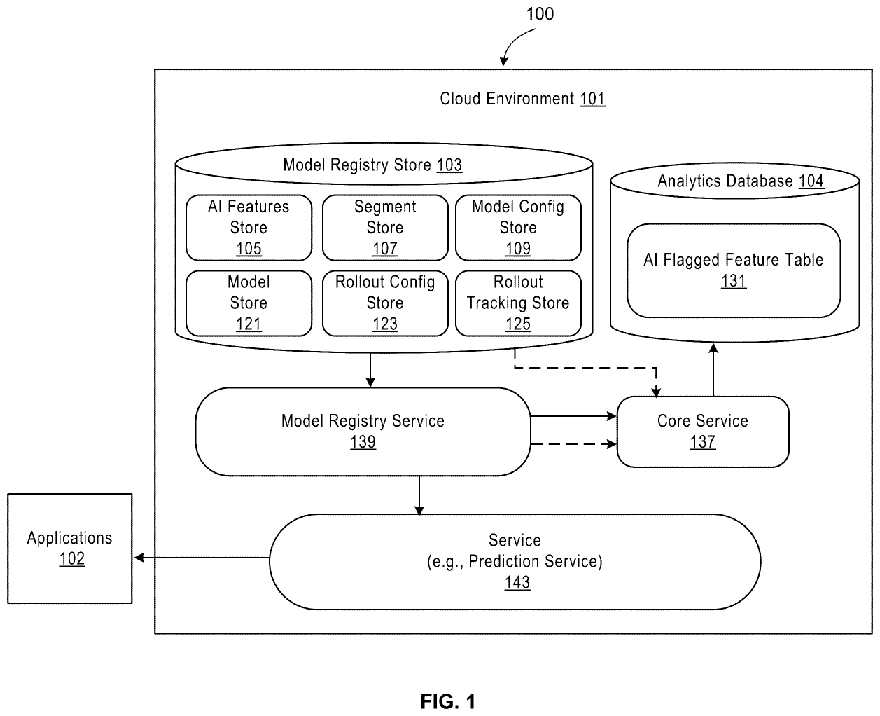

FIG. 1 is a schematic diagram illustrating a system 100 for managing artificial intelligence (AI) model rollouts according to an embodiment of the invention. As shown in FIG. 1, the system 100 includes a model registry store 103 and a model registry service 139. The model registry store 103 can be a database with a number of stores, each of which can be a collection object. For example, the model registry store 103 can include an AI feature store 105, a segment store 107, a model configuration store 109, a model store 121, a rollout configuration store 123, and a rollout tracking store 125.

In an embodiment, the AI feature store 105 can store different AI features and their associated information. Each entry in the AI feature store 105 can include the name of an AI feature, versions, and a description of the AI feature. An example entry in the AI feature store 105 is “probability score; 1; 1; score for measuring the probability a deal will close successfully”, where the “probability score” is the AI feature, the first “1” is the major version, the second “1” is the minor version; and the “score for measuring the probability a deal will close” is the description of the AI feature. The feature store 105 can be used to maintain feature flags for each AI feature, each major version of the AI feature, and each minor version of the major version.

An AI flagged feature table 131 in an analytics database 104 can store mapping entries between each flagged feature and its corresponding tenants. The model registry service 139 can call the core service 137 to retrieve one or more tenants that have flags turned on for a particular AI feature of each version of the AI model (e.g., be default, the latest version minor version).

In an embodiment, the segment store 107 can store segment definitions per AI feature per organization/tenant/user. The segment definitions can be used to extract training data during training time, and to resolve segment IDs during inference time. A large tenant may want to segment its data set into different segments for the same AI feature such that different AI models can be trained at the segment level to increase inference performance. In an embodiment, the model configuration store 109 can store training configuration information, which includes data configuration, e.g., Amazon s3 data location, and directed acyclic graphs (DAG) IDs; AI model configurations, e.g., hyperparameters, training container registry, and training output path; and deployment configurations, e.g., deployment location, target model prefix. The training configuration information stored in the model configuration store 109 would enable the training of a particular version of an AI model for a particular tenant/user. For each user, training configuration information can be located in the model configuration store 109. Default training configuration information is also stored in the model configuration store 109.

In an embodiment, the model store 121 can store different versions of trained AI models as well as locations of the trained models, corresponding training code versions, training data paths, training output metrics, deployment endpoints, model keys (i.e., target model names), inference data fetching codes, and inference code container URL.

In an embodiment, the rollout configuration store 123 stores rollout-related configurations, such as rollout windows (i.e., rollout durations) and smoothing algorithms. For example, the rollout window can be 6 months, and a smoothing algorithm can be an algorithm that takes a weighted average of output values from an old version and a new version of the AI model.

In an embodiment, the rollout tracking store 125 can store a rollout start date for each AI feature per tenant at both the major version level and minor version level. For example, the rollout tracking store 125 can store information specifying that the rollout date for a particular AI feature A is January 1 for tenant A and January 30 for tenant B at both the major version level and the minor version level.

Each of the above stores (e.g., collection objects) can have an API exposed through the model registry service 139. The APIs can be used by the model registry service 139 to interact with the model registry store 103 and other components in the system 100, such as the core service 137, to read AI model related data from and write AI model related to the model registry store 103. In an embodiment, the model registry service 139 can be hosted in one or more web instances. A service (e.g., a prediction service) 143 can use the model-related information via APIs exposed in the model registry service 139 to provide AI features to tenant applications 102.

In an embodiment, model related information in the model registry store 103 can be populated as described below.

When an administrator (i.e., a data scientist or another member on a data team in an organization) registers an AI feature version (i.e., a major version or a new minor version for a major version) by specifying an algorithm name, a default model configuration, and a default rollout configuration, the system 100 can automatically generate a corresponding version and AI feature flags in the AI features store 105 for the corresponding version. The AI feature flag enables training a model of the AI feature version.

A default AI model configuration can then be populated for a default organization, and a rollout configuration can also be generated for a specific rollout type (e.g., a major version rollout, or a minor version rollout).

Next, the administrator can populate segments for organizations using APIs, and turn on the “ModelTrainingFeatureFlag” flag for each organization so that those organizations that have enrolled for the AI features can start their model training on their segmented data.

In an embodiment, for a new AI feature version rollout, the administrator can turn on the AI feature flag for some tenants/organizations, and the rollout tracking store 125 can populate records for the new version rollout, with start days being specified for the new version rollout. During the rollout period (i.e., rollout window), the output value of the AI feature generated by the new version rollout can be a combination of output values of a prior version and a current version for a tenant if that tenant signed up for the AI feature during the rollout period.

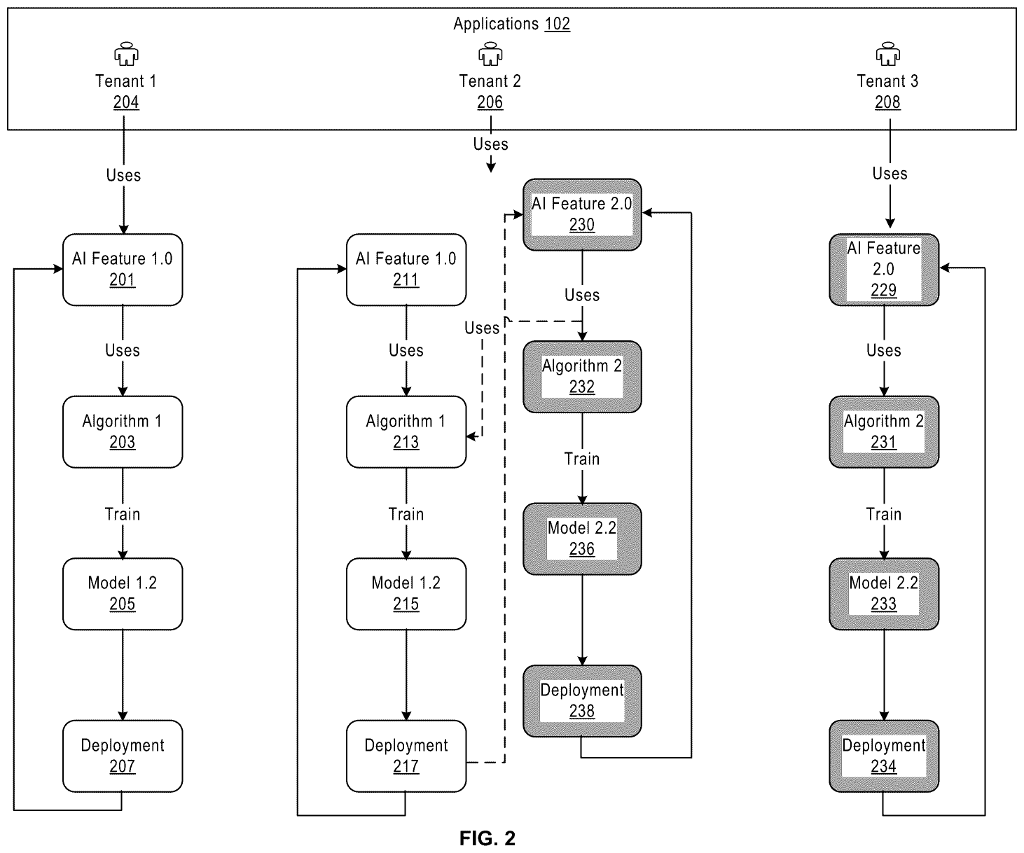

FIG. 2 illustrates specific use cases for the system 100 according to an embodiment of the invention. More specifically, FIG. 2 illustrates how different tenants can use the system 100 to customize their AI feature versions. Each tenant may have graphical use interface, wherein they can configure which version of the AI model they want to use.

In FIG. 2, each of tenants 204, 206 and 208 can receive the same AI feature in their respective applications 102, although the AI feature for each tenant may be generated by a different version of the same AI model, and thus has a different value.

As shown in FIG. 2, the tenant 204 uses an AI feature 201, the tenant 206 uses both the AI feature 211 and an AI feature 230, and the tenant 208 uses the AI feature 229. Each of the AI features 201, 211, 229, and 230 can have an output value of a different version of the same AI model in different deployments.

In an embodiment, the AI feature 201 can have an output value of a deployment 207 of an AI model 205, which implements an algorithm 203, and the AI feature 229 can have an output value of a deployment 234 of an AI model 233, which implements an algorithm 231. The values of the AI feature 211 and the AI feature 230 can be combined, e.g., according to an weighted average algorithm, to generate another value for the AI feature for use by the tenant 206, which, in an embodiment, may have signed up for the AI feature during a predetermined rollout window.

In an embodiment, the AI feature 211 can have an output value of a deployment 217 of an AI model 215, which implements an algorithm 213 (the same algorithm as the algorithm 203), and the AI feature 230 can have an output value of a deployment 238 of an AI model 236, which implements an algorithm 232 (the same algorithm as the algorithm 231). Since the AI model 215 and the AI model 205 belong to different customers, they are different objects and trained on different data. The same is true of the AI model 236 and the AI model 233.

In this figure, the AI model 233 and the AI model 205 can be different models, which are different versions of the same model, and each version therefore effectively is a different AI model, which is generated by implementing a different algorithm and/or training the prior model version on a different data. Each of the AI models 233 and 205 running in the deployments 207 and 234 can be invoked by the service 143 to provide a corresponding AI feature value.

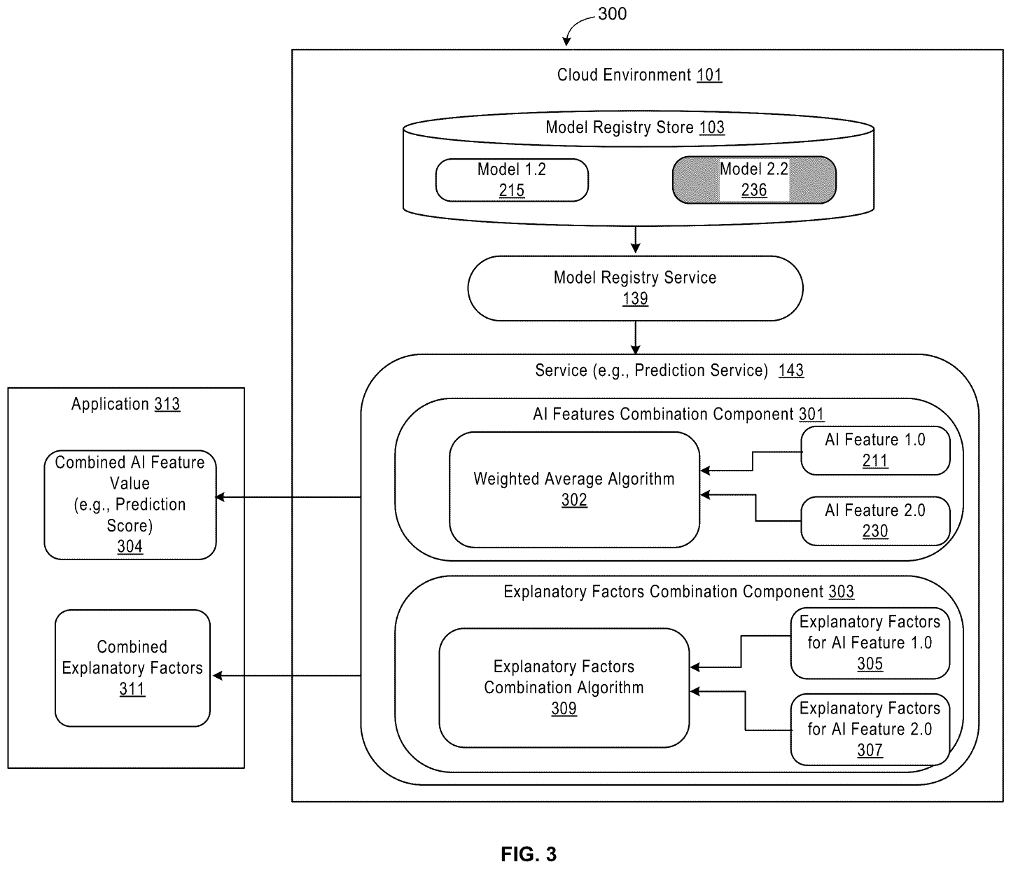

FIG. 3 illustrates a system of combining output values of AI features from multiple AI models according to an embodiment of the invention. More specifically, FIG. 3 illustrates in detail the use case for the tenant 206 in FIG. 2, that is, the tenant 206 can use a combined value of the output value of the AI feature 211 and the output value of the AI feature 230.

As shown FIG. 3, the service 143 can obtain model-related information via the model registry service 139 from the model registry store 103, and run the AI models 215 and 233 to provide a combined AI feature value 304 from the two AI models 215 and 236 to a tenant application 313, which, in one embodiment, is signed up for the AI feature during a rollout window.

In an embodiment, an AI feature combination component 301 can be used in the service 143 in combining the values of the AI features 211 and 230 using a weighted average algorithm 302, although other combination algorithms can also be used. Under the weighted average algorithm 302, a different weight can be given to the value of the AI feature 211 and the value of the AI feature 230 on a different date within a rollout window. Further, the weight given to the old AI model 215 decreases by a predetermined percentage for each subsequence date within the rollout window, and the weight given to the new AI model 236 increases by the same percentage for each subsequent date within the rollout window, such that by the end of the rollout window the old model is completely phased out and given 0 weight, and the new model 236 is given 100% weight.

As an illustrative example, for a planned release with a rollout window of 6 days, the system 100 can configure weights of the AI models 205 and 255 in Table 1 below:

TABLE 1

| Day of the Rollout | Model 1.2 215 (Old | Model 2.2 236 (New |
|---|---|---|
| Window | Model) | Model) |
| 1 | 100% | 0 |
| 2 | 80% | 20% |
| 3 | 60% | 40% |
| 4 | 40% | 60% |
| 5 | 20% | 80% |
| 6 | 0% | 100% |

As shown in Table 1 above, the weights given to the old AI model 215 (i.e., to the AI feature 211) gradually decreases from 100% to 0% uniformly over the rollout window, meaning that the percentage decrease for each date within the rollout window is the same. In the meantime, the weights given to the new model 236 (i.e., to the AI feature 230) increases from 0% to 100% uniformly over the rollout window.

In an embodiment, the model weights in Table 1 above might not always change linearly with time. They can also change in a non-linear manner. For example, a weight of the new model 236 on a particulate date in the rollout window can be calculated using the formula: weight a=log (days since start)/log (total rollout days); and a weight for the old model 215 on the particular date can be calculated using the formula: weight b=1−weight a.

Yet in another embodiment, the weights for the old model 215 and the new model 236 can be based on rollout configuration implementations stored in the rollout configuration store 123.

Thus, in an embodiment, on the third day of the rollout window, the application 313 may receive a probability score—indicating the probability that a task will successfully close—that is calculated as follows:

$$Probability score ( i . e . , value of the AI feature ) = Output Value of AI feature 1. * 60 \% + Output Value of AI feature 2. * 40 \% .$$

In an embodiment, the weights given to the AI models 215 and 236 can also be used to determine the numbers of explanatory factors selected from each AI model. As used herein, an explanatory factor can be an attribute of the input data, for example, a stage of a task and a change of a stage of the task.

One way to generate the explanatory factors for each of the AI models 215 and 236 is to iteratively execute each AI model to generate multiple values (e.g., probability scores) of the AI feature; and for each iteration, an input attribute is removed. The attribute whose removal results in a change exceeding a threshold can be selected as one of the explanatory factors. In one embodiment, each selected explanatory factor may account for a predetermined portion of the probability score. For example, in order to be selected as a factor (e.g., an input feature/attribute for training the ML model), that factor must account for at least 10% of the probability score.

Thus, each of the AI models 215 and 236 may have a number of associated explanatory factors generated using the approach above. An explanatory factors combination component 303 that implements an explanatory factors combination algorithm 309 can be used to generate a list of combined explanatory factors 311 to be displayed with the combined AI feature value 304 for the AI feature in the application 313.

The explanatory factors combination algorithm 309 can consider the weights given to each of the AI model 215 and 236 when selecting explanatory factors to form the combined explanatory factors list 311.

For example, for the combined AI feature value 304 on the third day of the rollout window as illustrated in Table 1 above, three top explanatory factors can be selected from the explanatory factors 305 for the old AI model 215, and two top explanatory factors can be selected from the explanatory factors 307 for the new AI model 233, because the weight given to the old AI model 215 is 60% on the third day, and the weight given to the new AI model 236 is 40% on that date.

The above example is provided to illustrate the concept that weights given to each of the AI model 214 and 236 can be used in creating the combined explanatory factors list 311. Many other different algorithms can be used to generate such list as long as the weights given to each AI model is considered.

In an embodiment, the rollout window and weights given to the AI models 215 and 236 are configurable.

The embodiments described above enable the combined AI feature value 304 to be used for the duration of the configurable rollable window. After the rollout window, values of the old AI model 215 would not be completely discarded, and only values of the new AI model 236 would be displayed to the tenant application 313.

Since the tenant associated with the tenant application 313 does not know that the combined AI feature value 304 as well as the accompanying combined explanatory factors list 311 are combination results from two different AI models, the tenant would not notice any disruption in the AI feature value, even if there is any, thus smoothing the user experience of the tenant during the rollout window.

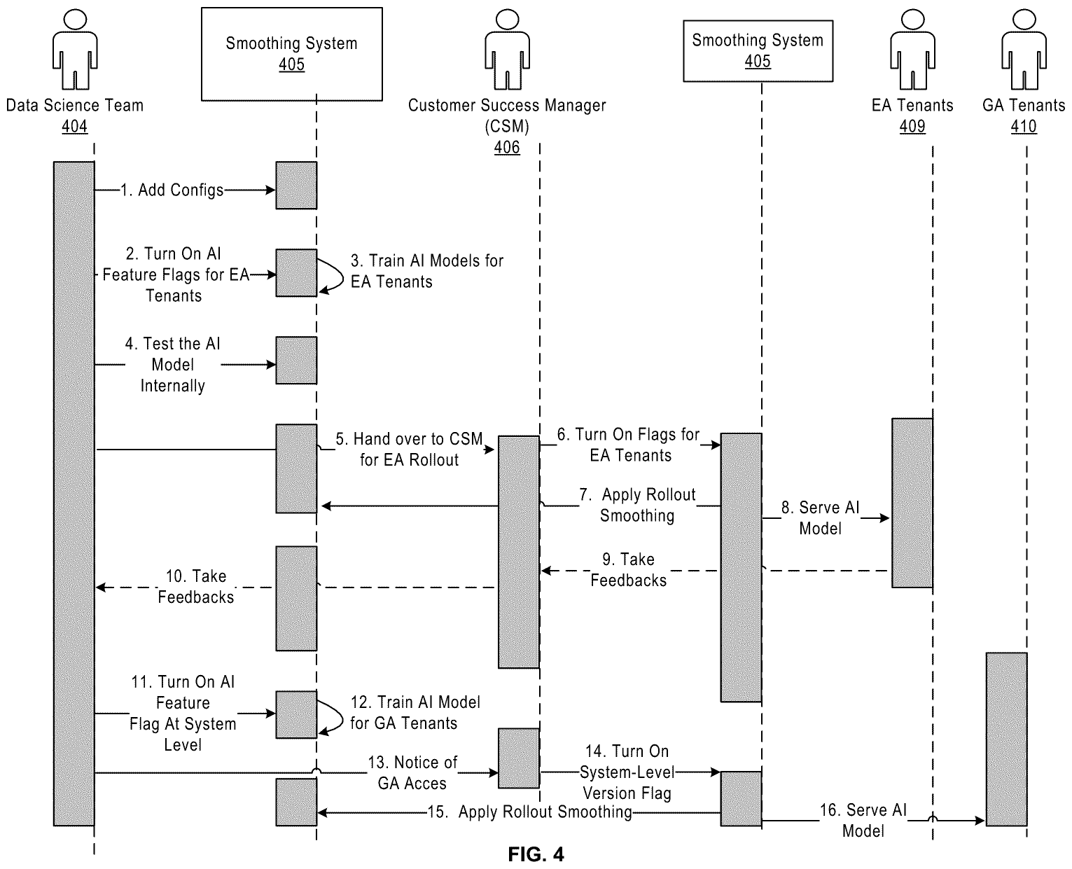

FIG. 4 illustrates a rollout process for a major version of an AI model according to an embodiment of the invention. In this embodiment, an AI model trained to provide probability scores indicating the likelihood that tasks can be successfully closed successfully is used for illustration. The AI model can be used in a prediction service to generate the probability scores.

As shown in FIG. 4, the first step in the rollout process is that a data science team 404 adds AI model training configurations and model serving configurations to the model registry store 103 for a new algorithm. In other words, when an algorithm has been designed for improving the inference performance of the AI model, the data science team 404 can add configurations to an AI feature smoothing system 405 for the training and the serving of the AI model. The AI feature smoothing system 405 can be the system 100 described in FIG. 1.

The second step is that after the above-mentioned configurations have been added, the data science team 404 can turn on a training flag to trigger the model training, and then turn on an AI feature implementation flag using the model registry service 139 described in FIG. 1 for early access (EA) tenants, which have agreed to test the AI model that implements the new algorithm. The model training can start for the EA tenants at step 3.

Once the model training is completed, the data science team 404 can test the AI model internally at step 4, and then hand the AI model that has been tested to a customer/tenant success manager (CSM) 406 for rollout to the EA tenants step 5. Next, the CSM 406 can turn on feature flags for the EA tenants in the smoothing system 405 at step 6.

At step 7, the smoothing system 405 invokes the prediction API and resolve the correct version and apply rollout smoothing during the rollout window. At step 8, the smoothing system 405 can serve the AI model to the EA tenants 409. The CSM 406 receives feedbacks regarding the AI model from the EA tenants and send the feedbacks to the data science team 404 respectively at steps 9 and 10.

At step 11, the data science team 404 turns on a system-level implementation flag, which enables AI models to be trained for the general availability (GA) tenants 410. As shown, the smoothing system 405 starts to train AI models for the GA tenants 410 at step 12.

At step 13, the data science team 404 notifies the CSM 406 that the AI model is to be rolled out to the GA tenants 410.

At step 14, the CSM 406 turns on the flag such that the correct version of the AI model can be rolled out to the GA tenants 410.

At step 15, the smoothing system 405 invokes the AI model via the prediction service and applies AI feature smoothing during the rollout window.

At step 16, the smoothing system 405 serves the AI model to the GA tenants 410.

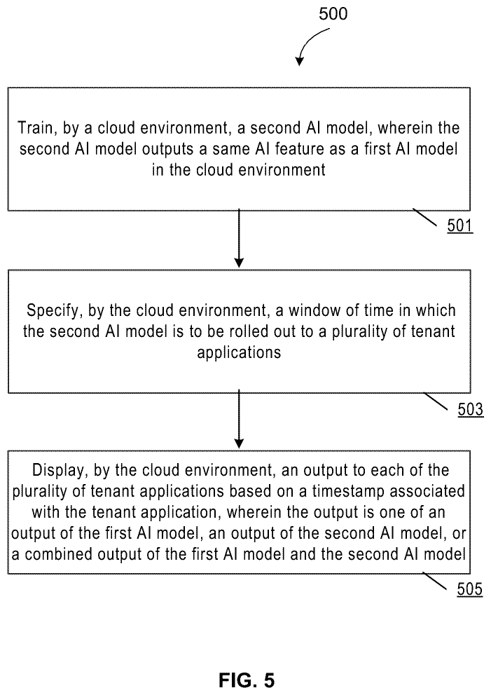

FIG. 5 illustrates a process of managing AI model rollouts according to an embodiment of the invention. The process may be performed by a processing logic that includes software, hardware, or a combination thereof. For example, the process may be performed by the service component 143 described in FIG. 1 and FIG. 3.

Referring to FIG. 5, in operation 501, the processing logic trains a second AI model in a cloud environment, which includes all the model configurations for training and serving the AI model at the tenant-level granularity. Each of the first AI model and the second AI model can be a neural network model, and both AI models have the same AI feature, meaning that both models are trained to perform the same functionality. However, the second AI model can be an updated version-either a major version indicating a major update, e.g., implementing a different algorithm, or a minor version indicating a minor update, e.g., being retrained on a new segment of data.

In operation 503, the processing logic specifies a window of time (rollout window) in which the second AI model is to be rolled out to a plurality of tenant applications. The window of time can also be preconfigured in the model registry store illustrated in FIG. 1, and the processing logic simply retrieves the window of time.

In operating 505, the processing logic displays an output value for consumption by each of the plurality of tenant applications based on a timestamp associated with the tenant application, where the output value is one of an output value of the first AI model, an output value of the second AI model, or a combined output value of the first AI model and the second AI model.

In this operation, different tenant applications may receive an output value from a different version of the AI model based on when the tenant application is signed up for the AI feature and/or other configurations.

In one implementation, a tenant application that is signed up for the AI feature prior to the start of the rollout window of the second AI model (i.e., the updated AI model) may receive the output value of the first AI model (i.e., the existing/old AI model), another tenant application that is signed up for the AI feature after the rollout window may receive the output value of the updated AI model, and a third tenant application that signed up for the AI feature during the rollout window can receive an combination of the output values from both AI models according to a weighted average combination algorithm.

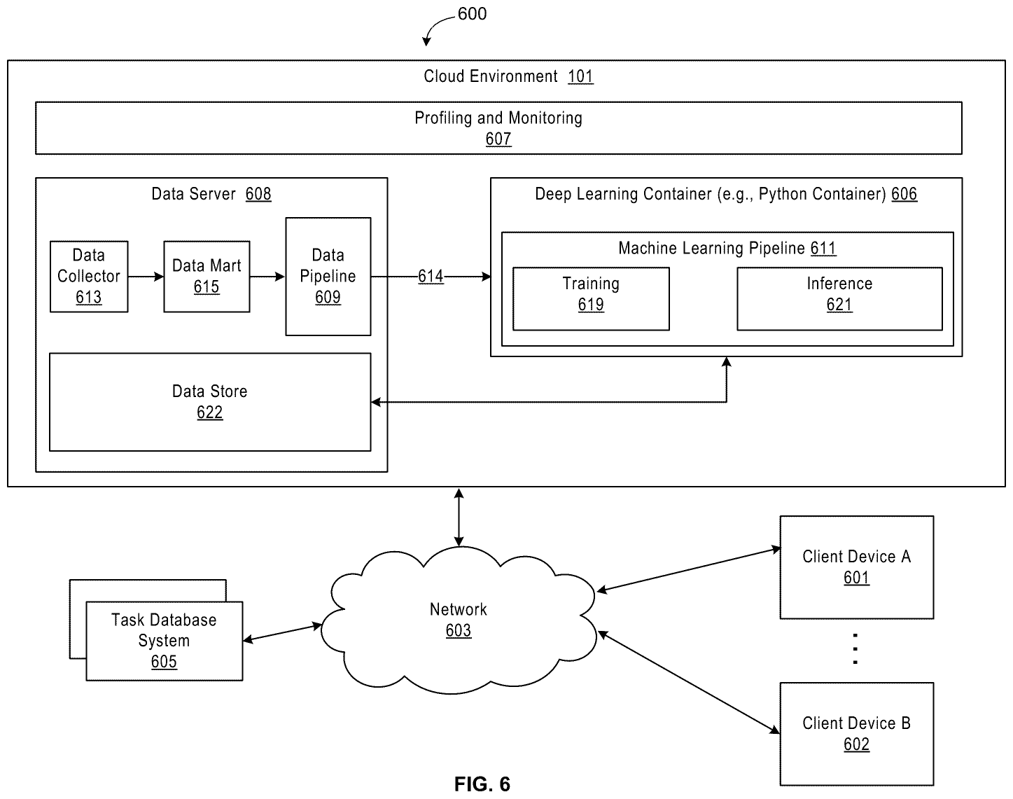

FIG. 6 is a block diagram illustrating an example system 600 of training a machine learning model for predicting probabilities of task completion in accordance with an embodiment. As shown in FIG. 6, the system 600 can include one or more clients 601-602 communicatively coupled to servers in the cloud environment 101 and a task database system 605 over network 603. The cloud environment 101 can further include a data server 608, and a deep learning container 606.

Clients 601-602 may be any type of clients such as a host or server, a personal computer (e.g., desktops, laptops, and tablets), a “thin” client, a personal digital assistant (PDA), a Web enabled appliance, or a mobile phone (e.g., Smartphone), etc. Network 603 may be any type of networks such as a local area network (LAN), a wide area network (WAN) such as the Internet, or a combination thereof, wired or wireless.

In one embodiment, the task database system 605 can be a customer relationship management (CRM) system that stores historical data and/or raw opportunity. The task database system 605 provides task data services and data to a variety of clients, which may be periodically or constantly accessed and updated by the clients for managing their task management data.

The data server 608 can be any kind of server, for example, a Web server, an application server, a backend server, etc. The data server 608 can include a data collector 613, a data mart 615, and a data pipeline 609. The data collector 613 can connect to the task database system 605 using a variety of communication protocols, and can be periodically updated from the task database system 605 or another data source or data provider. The data server 608 can perform Extract, Transform and Load (ETL) operations, and save the preprocessed data into the data mart 615, which represents a view of data retrieved from the task database system 605.

Based on configurations, the data collector 613 can retrieve different types of data from a number of data sources. The data collector 613 can retrieve task data (e.g., CRM data), activities data, account data, or any data that is needed for training ML model.

In one embodiment, a task can represent a deal, an opportunity, or a project in the task database system 605. A task needs to go through a number of predefined stages in the task database system to be considered completed or won or closed.

For example, a sales opportunity is an example of a task, which may need to progress through the stages of “new”, “pipeline”, “upside/best case”, “commit”, and “closed”. These stages are used as an example of a sales opportunity; a different set of stages can be defined for a sales opportunity or another type of task in the task database system 605. Activities data represents activities of a user assigned to complete a task, and can include emails exchanged between the user of the task and one or more contacts (outside parties) associated with the task; and past meetings and scheduled meetings between the user and the one or more contacts.

The data pipeline 609 can retrieve corresponding data from the data mart 615 with appropriate granularity, organize the data into appropriate formats, and send the organized data through representational state transfer (REST) application programming interfaces (API) in a streaming fashion. The data pipeline 609 can send data 614 using different signals to a machine pipeline 611 executed in the deep learning container 606 for the purpose of model training 619 and model inference 621.

The deep learning container 606 can be a Python container, which can execute a workflow that defines a number of phases for training a machine learning model. The Python container can be a Docker container, where a trained machine learning model can be provided as a micro-service via an API to users.

A data store 622 in the data server 608 can store an overall workflow defining stages for training ML models, and features that are to be used in training the ML models. The features and the workflow can be configured via one or more user interfaces in a client device.

In one embodiment, during the training phase 619, a number of predetermined machine learning models can be trained using the streaming data 614 from the data mart 615. During the inference phrase 621, a particular trained machine model can be selected to generate a score in response to receiving a new task to be scored. The value of the prediction score indicates the likelihood that the task can be closed.

The machine learning pipeline 611 can also generate a number of factors for explaining the prediction score. In one embodiment, the selected trained machine model can be iteratively executed to generate multiple prediction scores; and for each iteration, a feature is removed. The feature whose removal results in a biggest score change can be selected as one of the top explanatory factors.

In one embodiment, the example system 600 includes a profiling and monitoring module 607, which keeps track of training time for an ML model, the number of records/opportunities that the ML model has been trained on, the time it takes to generate a prediction score, and information for indicating the accuracy of the prediction score.

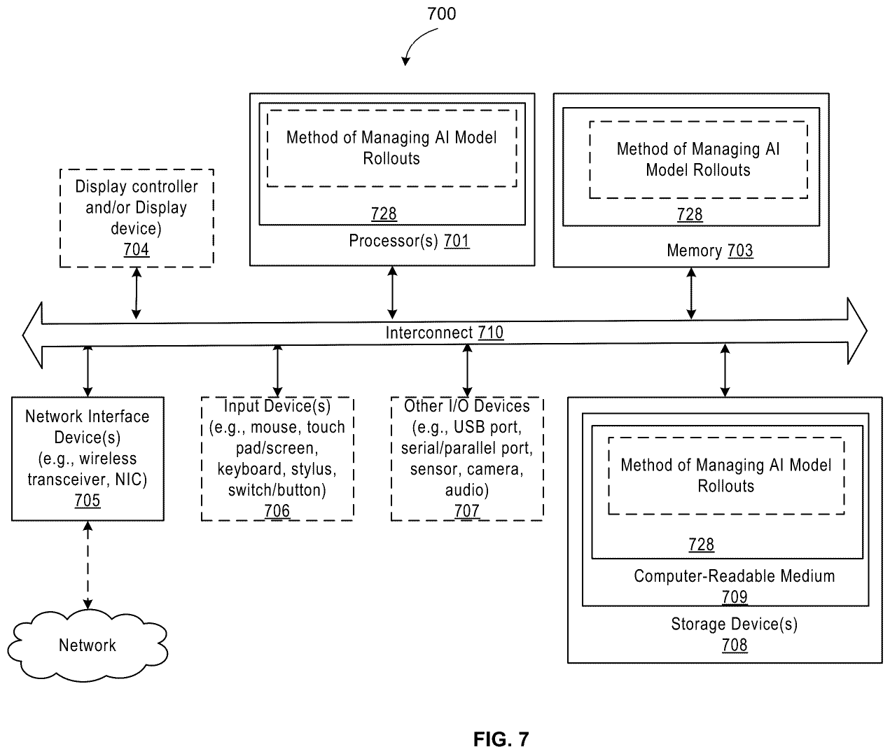

FIG. 7 is a block diagram illustrating an example of a data processing system 700 which may be used with any embodiment of the invention. For example, system 700 may represent any of the data processing systems described above, such as the system 100 and the system 300, performing any of the processes or methods described above. System 700 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system.

System 700 may represent a desktop, a laptop, a tablet, a server, a mobile phone, a media player, a personal digital assistant (PDA), a Smartwatch, a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

For one embodiment, system 700 includes processor 701, memory 703, and devices 705-708 via a bus or an interconnect 710. Processor 701 may represent a single processor or multiple processors with a single processor core or multiple processor cores included therein. Processor 701 may represent one or more general-purpose processors such as a microprocessor, a central processing unit (CPU), or the like. More particularly, processor 701 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 701 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 701, which may be a low power multi-core processor socket such as an ultra-low voltage processor, may act as a main processing unit and central hub for communication with the various components of the system. Such processors can be implemented as a system on chip (SoC). Processor 701 is configured to execute instructions for performing the operations and steps discussed herein. System 700 may further include a graphics interface that communicates with optional graphics subsystem 704, which may include a display controller, a graphics processor, and/or a display device.

Processor 701 may communicate with memory 703, which in one embodiment can be implemented via multiple memory devices to provide for a given amount of system memory. Memory 703 may include one or more volatile storage (or memory) devices such as random access memory (RAM), dynamic RAM (DRAM), synchronous DRAM (SDRAM), static RAM (SRAM), or other types of storage devices. Memory 703 may store information including sequences of instructions that are executed by processor 701, or any other device. For example, executable code and/or data of a variety of operating systems, device drivers, firmware (e.g., input output basic system or BIOS), and/or applications can be loaded in memory 703 and executed by processor 701. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 700 may further include IO devices such as devices 705-708, including network interface device(s) 705, optional input device(s) 707, and other optional IO device(s) 707. Network interface device 705 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 707 may include a mouse, a touch pad, a touch sensitive screen (which may be integrated with display device 704), a pointer device such as a stylus, and/or a keyboard (e.g., physical keyboard or a virtual keyboard displayed as part of a touch sensitive screen). For example, input device 706 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 707 may include an audio device. An audio device may include a speaker and/or a microphone to facilitate voice-enabled functions, such as voice recognition, voice replication, digital recording, and/or telephony functions. Other IO devices 707 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. Devices 707 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 710 via a sensor hub (not shown), while other devices such as a keyboard or thermal sensor may be controlled by an embedded controller (not shown), dependent upon the specific configuration or design of system 700.

To provide for persistent storage of information such as data, applications, one or more operating systems and so forth, a mass storage (not shown) may also couple to processor 701. In various embodiments, to enable a thinner and lighter system design as well as to improve system responsiveness, this mass storage may be implemented via a solid state device (SSD). However, for other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. A flash device may also be coupled to processor 701, e.g., via a serial peripheral interface (SPI). This flash device may provide for non-volatile storage of system software, including a BIOS as well as other firmware of the system.

Storage device 708 may include computer-accessible storage medium 709 (also known as a machine-readable storage medium or a computer-readable medium) on which is stored one or more sets of instructions or software (e.g., module, unit, and/or logic 728) embodying any one or more of the methodologies or functions described herein. Module/unit/logic 728 may represent any of the components described above. Module/unit/logic 728 may also reside, completely or at least partially, within memory 703 and/or within processor 701 during execution thereof by data processing system 700, memory 703 and processor 701 also constituting machine-accessible storage media. Module/unit/logic 728 may further be transmitted or received over a network via network interface device 705.

Computer-readable storage medium 709 may also be used to store some software functionalities described above persistently. While computer-readable storage medium 709 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of the present invention. The term “computer-readable storage medium” shall accordingly be taken to include, but not be limited to, solid-state memories, and optical and magnetic media, or any other non-transitory machine-readable medium.

Module/unit/logic 728, components and other features described herein can be implemented as discrete hardware components or integrated in the functionality of hardware components such as ASICS, FPGAs, DSPs or similar devices. In addition, module/unit/logic 728 can be implemented as firmware or functional circuitry within hardware devices. Further, module/unit/logic 728 can be implemented in any combination hardware devices and software components.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

Embodiments of the invention also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present invention are not described with reference to any programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method of managing artificial intelligence (AI) model rollouts, comprising:
training, by a cloud environment, a second AI model, wherein the second AI model outputs a same AI feature as a first AI model in the cloud environment;
specifying, by the cloud environment, a window of time in which the second AI model is to be rolled out to a plurality of tenant applications; and
displaying, by the cloud environment, an output value for the AI feature to each of the plurality of tenant applications based on a timestamp associated with the tenant application, wherein the output value is one of an output of the first AI model, an output value of the second AI model, or a combined output value of the first AI model and the second AI model.

2. The method of claim 1, wherein the timestamp represents a time when the tenant application is signed up for receiving the output value from the cloud environment.

3. The method of claim 1, wherein the combined output value is generated using a smoothing algorithm running in the cloud environment.

4. The method of claim 1, wherein the smoothing algorithm takes an weighted average of the output value from the first AI model and the output value from the second AI model to generate the combined output value.

5. The method of claim 4, wherein an weight of the output value of the first AI model gradually decreases from a start of the rollout window to and an end of the rollout window, and an weight of the output value of the second AI model proportionally decreases.

6. The method of claim 5, wherein the weight of the output value of the first AI model is 100% and the weight of the output value of the second AI model is 0 at the start of the rollout window.

7. The method of claim 5, wherein the weight of the output value of the first AI model is 0 and the weight of the output value of the second AI model is 100% at the end of the rollout window.

8. The method of claim 4, wherein the output value displayed to each of the plurality of tenant applications is accompanied by a plurality of explanatory factors.

9. The method of claim 8, wherein when the output value is the combined output value of the first AI model and the second AI model, the plurality of explanatory factors include more explanatory factors from one of the first AI model or the second AI model with a greater weight given in generating the combined output value.

10. The method of claim 1, wherein the output value displayed by the cloud environment to each of the plurality of tenant applications is a prediction score representing a probability that a task is to be successfully closed.

11. A data processing system, comprising:
a processor; and
a memory coupled to the processor to store instructions therein for managing artificial intelligence (AI) model rollouts, wherein the instructions, when executed by the processor, cause the processor to perform operations, the operations comprising:
training a second AI model in a cloud environment, wherein the second AI model outputs a same AI feature as a first AI model in the cloud environment;
specifying a window of time in which the second AI model is to be rolled out to a plurality of tenant applications; and
displaying an output value for the AI feature to each of the plurality of tenant applications based on a timestamp associated with the tenant application, wherein the output value is one of an output value of the first AI model, an output value of the second AI model, or a combined output value of the first AI model and the second AI model.

12. The data processing system of claim 11, wherein the timestamp represents a time when the tenant application is signed up for receiving the output value from the cloud environment.

13. The data processing system of claim 11, wherein the combined output value is generated using a smoothing algorithm running in the cloud environment.

14. The data processing system of claim 11, wherein the smoothing algorithm takes an weighted average of the output value from the first AI model and the output value from the second AI model to generate the combined output value.

15. The data processing system of claim 14, wherein an weight of the output value of the first AI model gradually decreases from a start of the rollout window to and an end of the rollout window, and an weight of the output value of the second AI model proportionally decreases.

16. The data processing system of claim 15, wherein the weight of the output value of the first AI model is 100% and the weight of the output value of the second AI model is 0 at the start of the rollout window.

17. The data processing system of claim 15, wherein the weight of the output value of the first AI model is 0 and the weight of the output value of the second AI model is 100% at the end of the rollout window.

18. The data processing system of claim 14, wherein the output value displayed to each of the plurality of tenant applications is accompanied by a plurality of explanatory factors.

19. The data processing system of claim 18, wherein when the output value is the combined output value of the first AI model and the second AI model, the plurality of explanatory factors include more explanatory factors from one of the first AI model or the second AI model with a greater weight given in generating the combined output value.

20. A non-transitory computer-readable medium that stores instructions for managing artificial intelligence (AI) model rollouts, which instructions, when executed by a data processing system comprising at least one hardware processor, cause the data processing system to perform operation comprising:
training a second AI model in a cloud environment, wherein the second AI model outputs a same AI feature as a first AI model in the cloud environment;
specifying a window of time in which a second AI model is to be rolled out to a plurality of tenant applications; and
displaying an output value for the AI feature to each of the plurality of tenant applications based on a timestamp associated with the tenant application, wherein the output value is one of an output value of the first AI model, an output value of the second AI model, or a combined output value of the first AI model and the second AI model.
